(19) United States
(12) Patent Application Publication
(10) Pub. No.: US 2025/0227476 A1
(43) Pub. Date: Jul. 10, 2025

(54) FAST MAC ADDRESS ROTATION THROUGH EXISTING STREAM CIPHER

(71) Applicant: Cisco Technology, Inc., San Jose, CA (US)

(72) Inventors: Domenico Ficara, Essertines-sur-Yverdon (CH); Ugo Mario Campiglio, Morges (CH); Jerome Henry, Pittsboro, NC (US); Javier I. Contreras Albesa, Sant Cugat del Valles (ES)

(21) Appl. No.: 18/987,303

(22) Filed: Dec. 19, 2024

Related U.S. Application Data
(60) Provisional application No. 63/618,967, filed on Jan. 9, 2024.

(51) Int. Cl. H04W 12/48; H04W 12/037; H04W 12/0471

(52) U.S. Cl. CPC H04W 12/48; H04W 12/037; H04W 12/0471

(57) ABSTRACT

Presented herein are techniques to efficiently rotate a Media Access Control (MAC) address. One or more stream ciphers for encrypting one or more data units are generated. A data unit of the one or more data units is encrypted using a stream cipher of the one or more stream ciphers to generate an encrypted data unit. A new MAC address to add to the data unit is generated based on the one or more stream ciphers and the encrypted data unit is wirelessly transmitted with the new MAC address.

### CROSS REFERENCE TO RELATED APPLICATION

This application claims priority to U.S. Application No. 63/618,967, filed Jan. 9, 2024, the entirety of which is incorporated herein by reference.

### TECHNICAL FIELD

The present disclosure relates to secure wireless networking.

### BACKGROUND

The Institute of Electrical and Electronics Engineers (IEEE) 802.11bi standard aims to provide wireless clients or stations with the ability to avoid being tracked in a wireless network. To prevent being tracked, an address associated with the clients may be changed or rotated. High frequency Media Access Control (MAC) address rotations are inefficient because of the associated overhead on the wireless network infrastructure, etc. An efficient means of frequently rotating a station's MAC address is highly beneficial to minimize impact to the wireless network infrastructure.

### BRIEF DESCRIPTION OF THE DRAWINGS

FIG. 1 is a high-level diagram of a wireless network in which the techniques presented herein may be employed, according to an example embodiment.

FIG. 2 is a flow diagram illustrating a transmitter device-side method of prepending an encrypted a MAC protocol data unit (MPDU) with an encrypted padding that was generated at a previous frame, according to an example embodiment.

FIG. 3 is a flow diagram illustrating a receiver device-side method of decrypting an MPDU received with an encrypted padding that was generated at a previous frame, according to an example embodiment.

FIG. 4 is a flow chart of a method of determining a new MAC address to append to a data unit based on a stream cipher, according to an example embodiment.

FIG. 5 is a flow chart of a method of decrypting an encrypted data unit using a key obtained from a data store, according to an example embodiment.

FIG. 6 illustrates a hardware block diagram of device that may perform functions associated with operations presented herein, according to an example embodiment.

### DETAILED DESCRIPTION

### Overview

In one embodiment, a method is provided to wirelessly transmit an encrypted data unit with a new MAC address. The method includes generating one or more streams ciphers for encrypting one or more data units. A data unit of the one or more data units is encrypted using a stream cipher of the one or more stream ciphers to generate an encrypted data unit. A new MAC address is generated to add to the data unit based on the one or more stream ciphers, and the encrypted data unit is wirelessly transmitted with the new MAC address.

In another embodiment, a method is provided to decrypt an encrypted data unit and store an identifier for a data unit. The method includes obtaining an encrypted data unit and an encrypted padding. A lookup is performed in a data store using the encrypted padding to obtain an identifier associated with a device that transmitted the encrypted data unit and a key to decrypt the encrypted data unit. A second padding is appended to the encrypted data unit. The key is used to decrypt the encrypted data unit to generate a data unit and encrypt the second padding to generate an encrypted second padding. The encrypted second padding with the identifier associated with the device that transmitted the encrypted data unit is stored in the data store.

### Example Embodiments

To avoid being tracked in a wireless network, any observable parameters or header fields that help in tracking a particular station (STA) or wireless client should be obfuscated or rotated. For simplicity, “STA”, “client” and “wireless client” are used herein interchangeably. In particular, the over-the-air (OTA) MAC (otaMAC) address of the client or STA or, in uplink (UL) streams, the transmit address (TA), may be used to track a client's activities over time. The longer a STA uses the same TA, the easier it is for an observer to start establishing traffic patterns for the MAC address associated with the STA and, therefore, fingerprint the STA.

Initial IEEE 802.11bi discussions were about mass address rotations in which all stations rotate their MAC addresses at the same time. However, an individual STA may have reasons to rotate its TA on its own, between the mass rotation intervals. For example, a STA may want to rotate its MAC address because it roams, because it sends sensitive/easy to fingerprint traffic, or for other additional or different reasons. A growing interest in high-frequency MAC address rotations, possibly performing a rotation as often as each transmit opportunity (TXOP), has developed. However, in such scenarios, methods by which a station pre-informs the station's access point (AP) of its next TA-MAC address become inefficient because of the associated overhead.

Presented herein are techniques that provide the option of performing frequent station TA rotations with high efficiency, but low overhead. In some embodiments, a method of randomizing MAC addresses is provided that may be performed on a per frame basis. The primary target use case is the STA TA (in UL flows), which is sometimes referred to herein as the otaMAC address, but the same process may be applied to any TA.

According to some embodiments described herein, a new or rotated otaMAC address may be computed as an output of a stream cipher used for encrypting a data unit. For example, the otaMAC address may be computed as an output of a stream cipher used for encryption using the Counter Mode Cipher Block Chaining Message Authentication Code Protocol (CCMP)/Galois Counter Mode Protocol (GCMP). In other embodiments, the otaMAC address may be computed using the stream cipher. For example, the otaMAC address may be computed by performing an exclusive-or operation with the previous MAC address of the station and a portion of the stream cipher, by performing an exclusive-or operation with a known tag (e.g., a 6 byte tag) and a portion of the stream cipher, or by performing a different computation or operation with the stream cipher or a portion of the stream cipher.

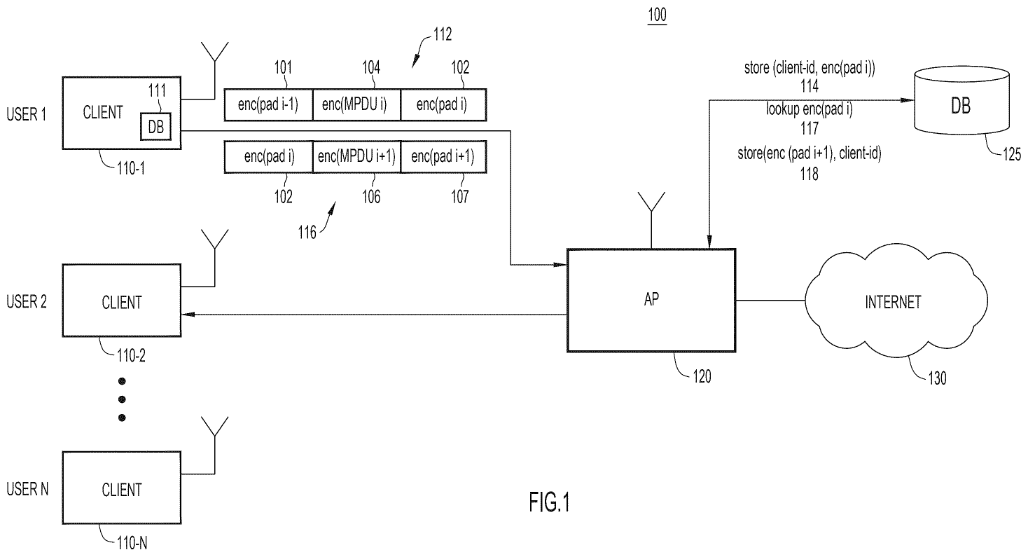

Reference is now first made to FIG. 1. FIG. 1 is a high-level diagram showing a wireless network 100 that includes a plurality of wireless clients or stations (STAs) 110-1, 110-2, 110-N and a wireless access point (AP) 120 that has a wired connection to a network, such as the Internet 130. The AP 120 and wireless clients 110-1 to 110-N communicate with each other using a wireless communication standard, such as the IEEE 802.11 wireless local area network (WLAN) standard. Although only one AP 120 is illustrated in FIG. 1, wireless network 100 may include multiple APs that communicate with one another and with wireless clients to transmit information.

In some embodiments, one or more of the wireless clients 110-1 to 110-N may be a multi-link device that is capable of multi-link operations in which the multi-link device associates and exchanges data traffic on multiple wireless links simultaneously and independently. In this example, a particular wireless client may be a multi-link client that has multiple client identifiers. For example, each wireless link may be associated with a client identifier. In a similar manner, AP 120 may be a multi-link device that is capable of multi-link operations and has multiple identifiers, one for each wireless link.

Traditionally, wireless clients 110-1 to 110-N communicate by exchanging data units, such as MAC protocol data units (MPDUs). It is advantageous to avoid tracking activities of the clients transmitting data units exchanged in the wireless network. One way to avoid tracking of the clients is to rotate an address (e.g., MAC address, TA, otaMAC address, etc.) prepended to data units transmitted by the clients.

When a data unit is transmitted, the data unit may first be encrypted to obfuscate the data in the payload of the data unit. For encryption with all counter-mode approaches, a stream cipher is generated and the exclusive- or (XOR) logical operation is employed with the stream cipher and the data unit to perform the encryption. According to embodiments described herein, a portion of a stream cipher (e.g., six or more bytes of the stream cipher) is generated for encrypting a data unit and used to compute a new MAC address for a STA transmitting the data unit.

In one embodiment, the portion of the stream cipher may be used as the next MAC address. In another embodiment, the portion of the stream cipher may be XORed with a previous MAC address used by a STA to generate the next MAC address to be used by the STA. In yet another embodiment, the portion of the stream cipher may be XORed with a known tag (e.g., of the same length as the portion of the stream cipher) and used to generate the next MAC address.

FIG. 1 illustrates an additional embodiment in which a new MAC address is computed for a device transmitting a data unit. In the example illustrated in FIG. 1, wireless client 110-1 is transmitting an MPDU (e.g., MPDU i), via AP 120, to another device and rotating a MAC address for adding to MPDU i. In this example, for each new MPDU to encrypt, a padding is appended to the MPDU. The padding may be all zeros or some other predetermined pattern. A stream cipher is generated using a key, and the MPDU and the padding are XORed with the stream cipher to generate an encrypted MPDU(enc (MPDU i) 104) and an encrypted padding (enc(pad i) 102). Wireless client 110-1 may store the encrypted padding, enc(pad i) 102, in database 111.

Database 111 may store encrypted padding generated for data units transmitted by wireless client 110-1. In the case in which wireless client 110-1 is a multi-link device, database 111 may store client identifiers for each link and encrypted padding information for each of the client devices. As discussed further below, in some embodiments, database 111 may additionally store entries associated with AP 120.

To rotate its MAC address, wireless client 110-1 may prepend enc (MPDU i) 104 with an encrypted padding from a previous frame. For example, as described in more detail below, wireless client 110-1 may perform a lookup in database 111 to identify an encrypted padding from a previous frame (enc(pad i−1) 101). In this example, enc(pad i−1) 101 acts as an identifier for wireless client 110-1 for the frame associated with MPDU i.

At 112 in FIG. 1, wireless client 110-1 may transmit a frame that includes enc(pad i−1) 101, enc(MPDU i) 104, and enc(pad i) 102 to AP 120. AP 120 receives the frame from wireless client 110-1 and, at 114, the AP 120 stores the encrypted padding enc(pad i) 102 and an identifier (ID) for wireless client 110-1 (client-id) in database 125. In the case in which wireless client 110-1 is a multi-link device, the client-id may be a link identifier. Database 125 is a table or other type of data store that stores client (or link) identifiers and associated encrypted padding computed for data units transmitted by the clients. The key of the record in database 125 is the client-id. Database 125 may additionally store a key used to generate the stream cipher for encrypting the padding. In some embodiments, database 125 may be stored at AP 120. In other embodiments, database 125 may be stored in a different location that is accessible by AP 120.

Wireless client 110-1 may transmit a new data unit, MPDU i+1, with a new MAC address to AP 120. To compute the new MAC address, wireless client 110-1 appends a padding (pad i+1) to MPDU i+1 and encrypts the pad i+1 and the MPDU i+1 using a stream cipher to generate enc(pad i+1) 107 and enc(MPDU i+1) 106. Wireless client 110-1 performs a lookup in database 111 to retrieve enc(pad i) 102 of the previously transmitted data unit, MPDU i, which was previously stored in database 111. Wireless client prepends enc(pad i) 102 to enc(MPDU i+1) 106 and enc(pad i+1) 107 to create a new frame. In the new frame, enc(pad i) 102 acts an identifier associated with wireless client 110-1. Wireless client 110-1 stores the enc(pad i+1) 107 in database 111 with a key used to generate the stream cipher (and a client-id associated with the link in the example in which wireless client 110-1 is a multi-link device).

At 116, wireless client 110-1 transmits the new frame to AP 120. AP 120 receives the new frame, which includes enc(pad i) 102, enc(MPDU i+1) 106, and enc(pad i+1) 107, from wireless client 110-1. To identify the transmitter device associated with the identifier enc(pad i) 102, at 117, the AP 120 performs a lookup in database 125 using enc(pad i) 102 to obtain the client-id associated with en(pad i) 102. Enc(pad i) 102 was previously stored in database 125 and associated with the client-id associated with wireless client 110-1 at step 114. Based on performing the lookup using enc(pad i) 102, AP 120 obtains the client-id associated with wireless client 110-1 and determines that the new frame was transmitted by wireless client 110-1. AP 120 additionally obtains, from database 125, a key used to generate the stream cipher used to encrypt the data unit.

AP 120 appends a padding (pad i+1) to enc(MPDU i+1) and, using the received client-id and key, computes a tag, enc(pad i+1). At 118, AP 120 updates database 125 by storing the computed enc(pad i+1) in database 125 as (enc(pad i+1), client-id). As discussed above, wireless client 110-1 uses the encrypted padding generated for the previous successfully transmitted frame as the next MAC address. In this case, MPDU i+1 is the most recent successfully transmitted frame. Therefore, the next time wireless client 110-1 rotates its MAC address, the new MAC address for wireless client 110-1 that is prepended to the new MPDU (e.g., MPDU i+2) will be enc(pad i+1). When AP 120 receives a new frame that includes enc(pad+1), AP 120 may perform another lookup in database 125 to identify that enc(pad+1) is associated with the client-id of wireless client 110-1.

By using the encrypted padding of the previously transmitted frame as the identifier address of the transmitter device, the address associated with the transmitter device may be frequently rotated (e.g., every frame, every N frames (e.g., based on SN modulo N), every K seconds, upon additional signaling/negotiation, etc.) with low overhead. Because the STA does not have to pre-inform the AP of its next TA-MAC, the techniques described herein are efficient and allow a STA to rotate its MAC address more frequently.

Although the example illustrated in FIG. 1 describes an example in which a wireless client transmits a frame to AP 120, in other embodiments, a similar method may be applied in a scenario in which the AP 120 transmits a frame to a wireless client. In this scenario, the database 111 stored at the wireless client may include entries associated with AP 120 (or multiple entries associated with AP 120 if AP 120 is a multi-link device). In this case, AP 120 may perform the functions described above with respect to wireless client 110-1 and, when rotating its MAC address, AP 120 may prepend a data unit with the encrypted padding of a frame previously transmitted by AP 120. In this case, database 125 may store entries associated with data units transmitted by AP 120.

In this scenario, when the wireless client receives a frame transmitted by AP 120, the wireless client may perform a lookup in a database (e.g., database 111) using the encrypted padding of the previously transmitted frame, which is prepended to the received frame, to obtain an identifier associated with AP 120 and a key used to generate the stream cipher for encrypting the received data unit. Wireless client may append a padding to the received data unit and encrypt the padding using the key to generate an encrypted padding for the data unit. Wireless client may store the encrypted padding in the database 111 and associate the encrypted padding with an identifier of AP 120.

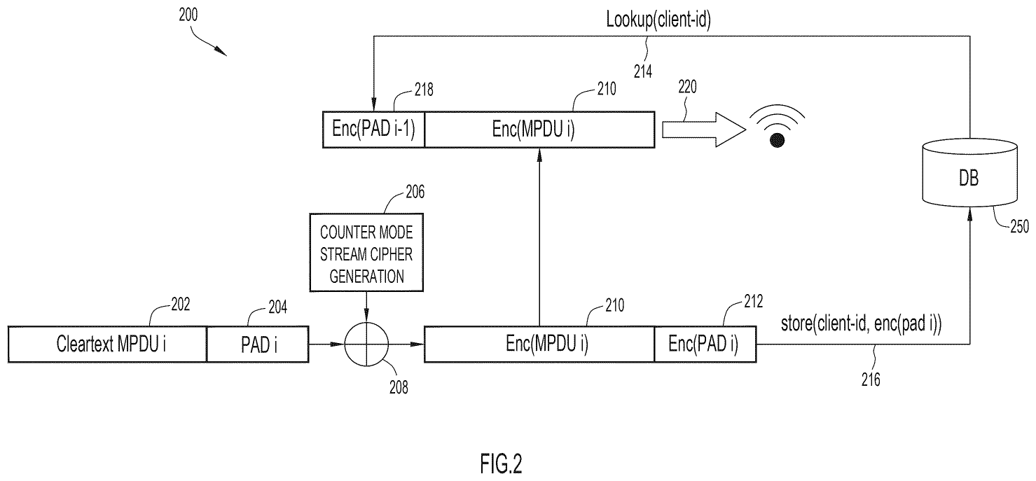

Reference is now made to FIG. 2. FIG. 2 is a flow diagram 200 illustrating a transmitter device-side method of prepending an encrypted MPDU with an encrypted padding that was generated at a previous frame. The method described in connection with FIG. 2 may be performed by a wireless client 110-1 to 110-N or AP 120.

As illustrated in FIG. 2, pad i 204 may be added to MPDU i 202. As described above, the padding may be, for example, all zeros or a predetermined pattern of digits. A stream cipher may be generated by counter mode stream cipher generation module 206 and, at 208, the MPDU i 202 and the pad i 204 may be XORed with a portion of the generated stream cipher to generate an encrypted MPDU(enc(MPDU i) 210) and an encrypted padding (enc(pad i)) 212.

At 214, the transmitter device performs a lookup in database 250 to obtain enc (pad i−1) 218. As discussed above with respect to FIG. 1, enc(pad i−1) 218 is the encrypted padding that was generated for the previous frame that was successfully transmitted by the transmitter device. In the case in which transmitter device is a multi-link device, enc(pad i−1) 218 is associated with the client-id in database 250 and the client-id is used to perform the lookup. The encrypted MPDU i, enc(MPDU i) 210, is prepended with enc(pad i−1) 218 to form a frame. In this example, enc(pad i−1) 218 is used as the new identifier or TA/otaMAC address for the transmitter device in the frame. At 216, enc(pad i) 212 is stored in database 250. In the case in which the transmitter device is a multi-link device, the client-id associated with the link is stored in database 250 with enc(pad i) 212. In this case, the key of the record in database 250 is the client-id and enc(pad i) 212 is associated with the client-id in database 250.

At 220, the frame is transmitted toward the destination or receiver device. For example, if the transmitter device is a client device, the frame may be transmitted toward an access point, such as AP 120. As another example, if the transmitter device is an access point, the frame may be transmitted toward a client device, such as wireless client 110-1 to 110-N.

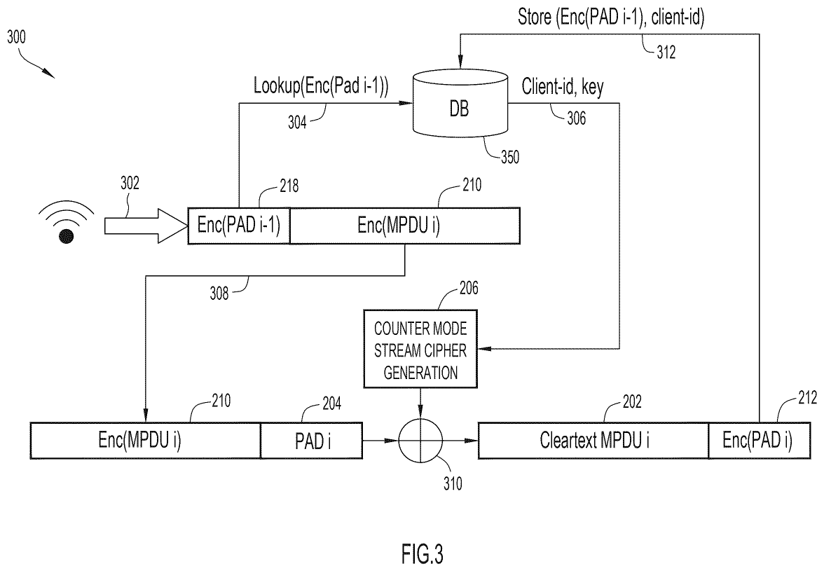

Reference is now made to FIG. 3. FIG. 3 is a flow diagram 300 illustrating a receiver device-side method of decrypting an MPDU received with an encrypted padding that was generated at a previous frame. The method described in FIG. 3 may be performed by a wireless client 110-1 to 110-N or AP 120.

As illustrated in FIG. 3, at 302, a frame that includes enc(pad i−1) 218 and enc(MPDU i) 210 is received at the receiver device. After receiving the frame, at 304, the tag, which is the encrypted padding of the previous frame (enc(pad i−1) 218) is used to perform a lookup in database 350 to identify an identifier of the transmitter device. At 306, database 350 returns the client-id and the key to use to generate the stream cipher that was used to encrypt enc (MPDU i) 210.

At the receiver side, since the GCMP stream is available, the next MAC address may be computed at the end of the reception of each frame and database 350 may be updated with the next MAC address. Since MPDU i has been successfully transmitted by the transmitter device, the next MAC address for the transmitter device associated with the client-id will be the encrypted pad i. In other words, the encrypted pad i will be prepended to the next MPDU (e.g., MPDU i+1) transmitted by the transmitter device and used as the next MAC address for the transmitter device. Therefore, the receiver device may update database 350 to associate the client-id of the transmitter device with the encrypted pad i so that the receiver device may obtain the identifier of the transmitter device when the receiver device receives a new frame that includes the encrypted pad i.

To compute the next MAC address to be used by the transmitter device associated with client-id, at 308, the encrypted MPDU (e.g., enc(MPDU i) 210) is obtained from the received frame and pad i 204 is appended to enc(MPDU i) 210. The counter mode stream cipher generation module 206 generates the stream cipher using the key obtained from database 350 and, at 310, the stream cipher is XORed with enc(MPDU i) 210 and pad i 204 to generate decrypted MPDU i 202 and encrypted pad i (e.g., enc(pad i) 212). The encrypted padding, which is the tag, is used as a key to store in database 350 with the same client-id and key that was received from database 350 at 306. At 312, enc(pad i) 212 is stored in database 350 as enc(pad i−1) along with the client-id of the transmitter device to be used by the transmitter device as the new MAC address the next time the transmitter device rotates its MAC address. In this way, when the receiver device receives a new data unit with a MAC address corresponding to enc(pad i−1), the receiver device can perform a lookup in database 350 to determine the client-id of the transmitter device.

Although several examples of ways in which a stream cipher is used to compute a new MAC address have been described above, other embodiments provide for additional ways to compute a new MAC address using a stream cipher. For example, in one embodiment, the transmitter (transmitting device), when desiring to rotate its MAC address, may prepend a pre-established tag in the first PDU where it wants to use the new MAC address. Because the stream cipher is known at the receiver (receiving) and transmitter (transmitting) sides, at each frame N, the receiver may compute the first bytes of the stream cipher for frame N+1 (as described in FIGS. 1-3).

In this embodiment, the receiver may perform an XOR operation using the computed first byes of the stream cipher for frame N+1 and the pre-established tag that the client and AP have agreed upon and the result may be stored in a lookup table. The receiver side, upon reception of a frame from an unknown MAC address, may look up the encrypted tag in the lookup table and determine that the transmitter has rotated its otaMAC address.

Rotation of the STA's MAC address is possible at every frame, at any regular interval, or at time the transmitter wishes to rotate the MAC address. In the case of aggregation (aggregated MAC service data unit (A-MSDU)/aggregated MPDU (A-MPDU)), because aggregation involves the same transmitter, it makes sense to avoid performing the MAC address rotation for the individual MPDUs or MSDUs within the aggregation.

In the case in which each frame holds a new otaMAC address (i.e., the case in which MAC address rotation occurs for each frame), if the frame for which the rotation occurs is lost or corrupted, it impedes the driver from decoding the next frames (if received correctly). However, if the length of the lost/corrupted frame is known, at the receiver side, the stream cipher may still be recovered (although not as quickly as in the regular case). If the occurrence of lost or corrupted frames becomes a problem (e.g., for voice calls), the otaMAC address may be rotated less frequently.

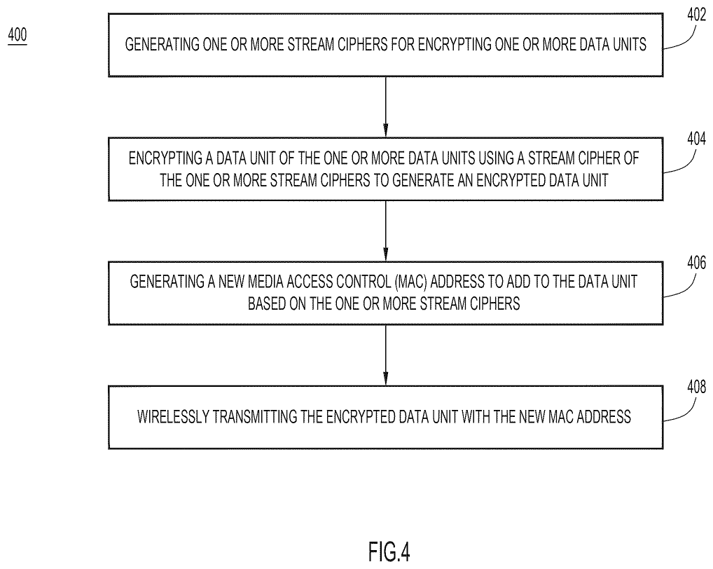

Reference is now made to FIG. 4. FIG. 4 is a flow chart of a method 400 of determining a new MAC address to add to a data unit based on a stream cipher. Method 400 may be performed, for example, by a client device, such as wireless client 110-1 to 110-N, or an access point, such as AP 120.

At 402, one or more stream ciphers may be generated for encrypting one or more data units. At 404, a data unit of the one or more data units is encrypted using a stream cipher of the one or more stream ciphers to generate an encrypted data unit.

At 406, a new media access control (MAC) address to add to the data unit may be determined based on the one or more stream ciphers. The new MAC address may be used to identify a device that transmitted the data unit. In one example, the new MAC address may be a portion of the stream cipher. In another example, the new MAC address may be generated by performing an XOR operation with a portion of the stream cipher and a previous MAC address of a transmitter device that transmitted the data unit to generate the new MAC address. In another example, the MAC address may be generated by performing an XOR operation with a portion of the stream cipher and a known tag. In yet another example, the MAC address may be generated based on an encrypted padding generated for a data unit previously transmitted by a device that transmitted the data unit.

At 408, the encrypted data unit is wirelessly transmitted with the new MAC address. For example, a frame with the encrypted data unit and the new MAC address may be wirelessly transmitted to a device or node.

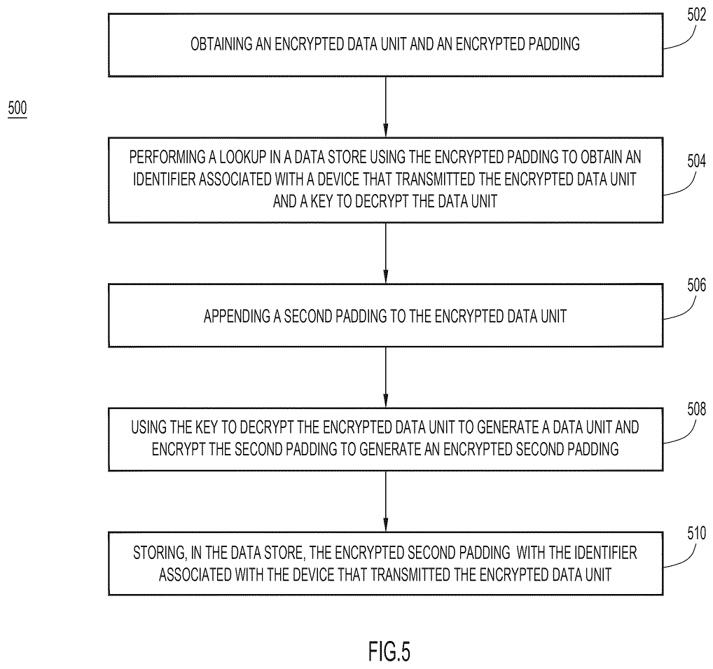

Reference is now made to FIG. 5. FIG. 5 is a flow chart of a method 500 of decrypting an encrypted data unit using a key obtained from a data store. Method 500 may be performed, for example, by a client device, such as wireless client 110-1 to 110-N, or an access point, such as AP 120.

At 502, an encrypted data unit and an encrypted padding are obtained. For example, a frame may be received that includes an encrypted data unit and an identifier that is an encrypted padding associated with a previously transmitted data frame. At 504, a lookup is performed in a data store using the encrypted padding to obtain an identifier associated with a device that transmitted the encrypted data unit and a key to decrypt the encrypted data unit.

At 506, a second padding is appended to the encrypted data unit. At 508, the key is used to decrypt the encrypted data unit to generate a data unit and encrypt the second padding to generate encrypted second padding. At 510, the encrypted second padding is stored, in a data store, with the identifier associated with the device that transmitted the encrypted data unit. In this way, the encrypted second padding may be used to identify the identifier associated with the device that transmitted the encrypted data unit when a new encrypted data unit that includes the encrypted second padding is received.

In summary, the techniques presented herein involve performing fast MAC address rotation to preserve privacy in IEEE 802.11. According to the techniques described herein, the MAC address rotation may be performed as frequently as every frame with low overhead and high efficiency. In particular, the techniques provide for generating a new MAC address for a transmitter device based on a stream cipher used to encrypt a data unit that is being transmitted by, or was transmitted by, the transmitter device.

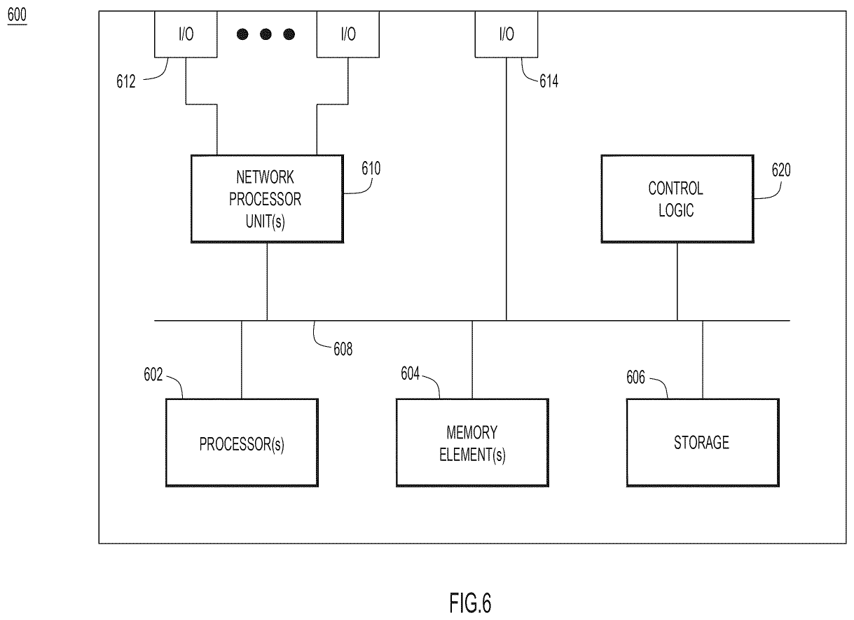

Referring to FIG. 6, FIG. 6 illustrates a hardware block diagram of device (e.g., AP 120 or wireless client 110-1 to 110-N) that may perform functions associated with operations discussed herein in connection with the techniques depicted in FIGS. 1-5.

In at least one embodiment, the apparatus 600 may be any apparatus that may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620. In various embodiments, instructions associated with logic for apparatus 600 can overlap in any manner and are not limited to the specific allocation of instructions and/or operations described herein.

In at least one embodiment, processor(s) 602 is/are at least one hardware processor configured to execute various tasks, operations and/or functions for apparatus 600 as described herein according to software and/or instructions configured for apparatus 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with apparatus 600, and/or logic configured for memory element(s) 604 and/or storage 606. For example, any logic described herein (e.g., control logic 620) can, in various embodiments, be stored for apparatus 600 using any combination of memory element(s) 604 and/or storage 606. Note that in some embodiments, storage 606 can be consolidated with memory element(s) 604 (or vice versa), or can overlap/exist in any other suitable manner.

In at least one embodiment, bus 608 can be configured as an interface that enables one or more elements of apparatus 600 to communicate in order to exchange information and/or data. Bus 608 can be implemented with any architecture designed for passing control, data and/or information between processors, memory elements/storage, peripheral devices, and/or any other hardware and/or software components that may be configured for apparatus 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between apparatus 600 and other systems, entities, etc., via network I/O interface(s) 612 (wired and/or wireless) to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between apparatus 600 and other systems, entities, etc. to facilitate operations for various embodiments described herein. In various embodiments, network I/O interface(s) 612 can be configured as one or more Ethernet port(s), Fibre Channel ports, any other I/O port(s), and/or antenna(s)/antenna array(s) now known or hereafter developed. Thus, the network processor unit(s) 610 and/or network I/O interface(s) 612 may include suitable interfaces for receiving, transmitting, and/or otherwise communicating data and/or information in a network environment.

I/O interface(s) 614 allow for input and output of data and/or information with other entities that may be connected to apparatus 600. For example, I/O interface(s) 614 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 620 can include instructions that, when executed, cause processor(s) 602 to perform operations, which can include, but not be limited to, providing overall control operations of apparatus; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to an apparatus for transfer onto another computer readable storage medium.

In one form, a method is presented including generating one or more stream ciphers for encrypting one or more data units; encrypting a data unit of the one or more data units using a stream cipher of the one or more stream ciphers to generate an encrypted data unit; generating a new media access control (MAC) address to add to the data unit based on the one or more stream ciphers; and wirelessly transmitting the encrypted data unit with the new MAC address.

In one example, generating the new MAC address includes: using a portion of the stream cipher as the new MAC address. In another example, generating the new MAC address includes performing an exclusive-or operation with a portion of the stream cipher and a previous MAC address of a transmitter device associated with the data unit to generate the new MAC address. In another example, generating the new MAC address includes performing an exclusive-or operation with a portion of one of the stream cipher and a predetermined tag to generate the new MAC address.

In another example, generating the new MAC address includes adding a padding to the data unit; encrypting the padding using the stream cipher of the one or more stream ciphers to generate an encrypted padding for the data unit; storing the encrypted padding for the data unit in a data store; performing a lookup in the data store to identify a previous encrypted padding associated with a previous data unit; and using the previous encrypted padding for the previous data unit as the new MAC address for the data unit.

In another example, the method further includes receiving, at a receiver device, the encrypted data unit with the previous encrypted padding associated with the previous data unit as the new MAC address; performing a lookup in a second data store using the previous encrypted padding associated with the previous data unit to identify a device that transmitted the data unit and a key used to generate the stream cipher; and decrypting the data unit using the key. In another example, the data unit is a MAC protocol data unit (MPDU) and wirelessly transmitting includes wirelessly transmitting the encrypted data unit with the new MAC address according to an IEEE 802.11 wireless networking protocol. In another example, the method is performed by a client device or an access point.

In another form, an apparatus is provided including: a memory; a network interface configured to enable network communication; and a processor, wherein the processor is configured to perform operations including: generating one or more stream ciphers for encrypting one or more data units; encrypting a data unit of the one or more data units using a stream cipher of the one or more stream ciphers to generate an encrypted data unit; generating a new media access control (MAC) address to add to the data unit based on the one or more stream ciphers; and causing the encrypted data unit with the new MAC address to be wirelessly transmitted.

In another form, another method is provided that includes obtaining an encrypted data unit and an encrypted padding; performing a lookup in a data store using the encrypted padding to obtain an identifier associated with a device that transmitted the encrypted data unit and a key to decrypt the encrypted data unit; appending a second padding to the encrypted data unit; using the key to decrypt the encrypted data unit to generate a data unit and encrypt the second padding to generate an encrypted second padding; and storing, in the data store, the encrypted second padding with the identifier associated with the device that transmitted the encrypted data unit.

In one example, the method is performed by a client device. In another example, the method is performed by an access point. In another example, the encrypted padding is associated with a second data unit previously transmitted by the device that transmitted the encrypted data unit. In another example, the encrypted padding is a MAC address associated with the device that transmitted the encrypted data unit. In another example, using the key to decrypt the encrypted data unit and encrypt the second padding includes using the key to generate a stream cipher to use to decrypt the encrypted data unit and encrypt the second padding.

In still further embodiments, the methods presented herein may be embodied by instructions encoded in one or more non-transitory computer readable storage media that, when executed by one or more processors, causes the one or more processors to perform the operations described for the methods discussed herein.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

As used herein, the terms “approximately,” “generally,” “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to convey that the property value may be within +/−5%, within +/−4%, within +/−3%, within +/−2%, within +/−1%, or even closer, of the given value. Similarly, when a given feature is described as being “substantially parallel” to another feature, “generally perpendicular” to another feature, and so forth, this is intended to convey that the given feature is within +/−5%, within +/−4%, within +/−3%, within +/−2%, within +/−1%, or even closer, to having the described nature, such as being parallel to another feature, being perpendicular to another feature, and so forth. Mathematical terms, such as “parallel” and “perpendicular,” should not be rigidly interpreted in a strict mathematical sense, but should instead be interpreted as one of ordinary skill in the art would interpret such terms. For example, one of ordinary skill in the art would understand that two lines that are substantially parallel to each other are parallel to a substantial degree, but may have minor deviation from exactly parallel.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
generating one or more stream ciphers for encrypting one or more data units;
encrypting a data unit of the one or more data units using a stream cipher of the one or more stream ciphers to generate an encrypted data unit;
generating a new media access control (MAC) address to add to the data unit based on the one or more stream ciphers; and
wirelessly transmitting the encrypted data unit with the new MAC address.

2. The method of claim 1, wherein generating the new MAC address comprises:
using a portion of the stream cipher as the new MAC address.

3. The method of claim 1, wherein generating the new MAC address comprises:
performing an exclusive-or operation with a portion of the stream cipher and a previous MAC address of a transmitter device associated with the data unit to generate the new MAC address.

4. The method of claim 1, wherein generating the new MAC address comprises performing an exclusive-or operation with a portion of one of the stream cipher and a predetermined tag to generate the new MAC address.

5. The method of claim 1, wherein generating the new MAC address comprises:
adding a padding to the data unit;
encrypting the padding using the stream cipher of the one or more stream ciphers to generate an encrypted padding for the data unit;
storing the encrypted padding for the data unit in a data store;
performing a lookup in the data store to identify a previous encrypted padding associated with a previous data unit; and
using the previous encrypted padding for the previous data unit as the new MAC address for the data unit.

6. The method of claim 5, further comprising:
receiving, at a receiver device, the encrypted data unit with the previous encrypted padding associated with the previous data unit as the new MAC address;
performing a lookup in a second data store using the previous encrypted padding associated with the previous data unit to identify a device that transmitted the data unit and a key used to generate the stream cipher; and
decrypting the data unit using the key.

7. The method of claim 1, wherein the data unit is a MAC protocol data unit (MPDU) and wirelessly transmitting comprises wirelessly transmitting the encrypted data unit with the new MAC address according to an IEEE 802.11 wireless networking protocol.

8. The method of claim 1, wherein the method is performed by a client device or an access point.

9. An apparatus comprising:
a memory;
a network interface configured to enable network communication; and
a processor, wherein the processor is configured to perform operations comprising:
generating one or more stream ciphers for encrypting one or more data units;
encrypting a data unit of the one or more data units using a stream cipher of the one or more stream ciphers to generate an encrypted data unit;
generating a new media access control (MAC) address to add to the data unit based on the one or more stream ciphers; and
causing the encrypted data unit with the new MAC address to be wirelessly transmitted.

10. The apparatus of claim 9, wherein the operation of generating the new MAC address comprises:
using a portion of the stream cipher as the new MAC address.

11. The apparatus of claim 9, wherein the operation of generating the new MAC address comprises:
performing an exclusive-or operation with a portion of the stream cipher and a previous MAC address of a transmitter device associated with the data unit to generate the new MAC address.

12. The apparatus of claim 9, wherein the operation of generating the new MAC address comprises:
performing an exclusive-or operation with a portion of one of the stream cipher and a predetermined tag to generate the new MAC address.

13. The apparatus of claim 12, wherein the operation of generating the new MAC address comprises:
adding a padding to the data unit;
encrypting the padding using the stream cipher of the one or more stream ciphers to generate an encrypted padding for the data unit;
storing the encrypted padding for the data unit in a data store;
performing a lookup in the data store to identify a previous encrypted padding associated with a previous data unit; and
using the previous encrypted padding associated with the previous data unit as the new MAC address for the data unit.

14. The apparatus of claim 9, wherein the data unit is a MAC protocol data unit (MPDU) and wirelessly transmitting comprises wirelessly transmitting the encrypted data unit with the new MAC address according to an IEEE 802.11 wireless networking protocol.

15. A method comprising:
obtaining an encrypted data unit and an encrypted padding;
performing a lookup in a data store using the encrypted padding to obtain an identifier associated with a device that transmitted the encrypted data unit and a key to decrypt the encrypted data unit;
appending a second padding to the encrypted data unit;
using the key to decrypt the encrypted data unit to generate a data unit and encrypt the second padding to generate an encrypted second padding; and
storing, in the data store, the encrypted second padding with the identifier associated with the device that transmitted the encrypted data unit.

16. The method of claim 15, wherein the method is performed by a client device.

17. The method of claim 15, wherein the method is performed by an access point.

18. The method of claim 15, wherein the encrypted padding is associated with a second data unit previously transmitted by the device that transmitted the encrypted data unit.

19. The method of claim 15, wherein the encrypted padding is a MAC address associated with the device that transmitted the encrypted data unit.

20. The method of claim 15, wherein using the key to decrypt the encrypted data unit and encrypt the second padding includes using the key to generate a stream cipher to use to decrypt the encrypted data unit and encrypt the second padding.
